(19) United States
(12) Patent Application Publication
(10) Pub. No.: US 2019/0172415 A1
(43) Pub. Date: Jun. 6, 2019

(54) Remote Color Matching Process and System

(71) Applicants: Dennis Willard Davis, Palm Bay, FL (US); Alice McKinstry Davis, Palm Bay, FL (US)

(72) Inventors: Dennis Willard Davis, Palm Bay, FL (US); Alice McKinstry Davis, Palm Bay, FL (US)

(21) Appl. No.: 16/350,553

(22) Filed: Nov. 30, 2018

Related U.S. Application Data
(60) Provisional application No. 62/708,073, filed on Dec. 1, 2017.

(51) Int. Cl. G09G 5/02; G06T 7/90; G06K 9/46; H04M 1/725

(52) U.S. Cl. CPC G09G 5/02; G06T 7/90; G06K 9/4652; H04M 2201/38; G09G 2340/14; G09G 2320/0666; G06T 2207/10024; H04M 1/72522

(57) ABSTRACT

Disclosed is a method and system for cost effective, convenient remote color reproduction and matching that can be used by product vendors and consumers. In a preferred embodiment, the method comprises capture of product color spectra using a spectrometer under controlled illumination, the calculation of optimum coloring mixing levels for a multi-primary display using primaries optimized to reduce observer metamerism, and the use of these mixing levels in a remote display exhibiting the optimized primaries in order to render the original product color in high fidelity. Other embodiments of the method and system include measurement of the consumer's CMF, filtering of the product color spectrum with these CMFs, and display of the color resulting from these tristimulus values on a remote RGB display. Various alternatives are disclosed for components of the system.

### CROSS-REFERENCE TO RELATED APPLICATIONS

This application claims the benefit of U. S. provisional application Patent Application Ser. No. 62/708,073, filed Dec. 1, 2017 for “Remote Color Matching Process and System Useful for Online Purchases” by Dennis W. Davis and Alice M. Davis.

### BACKGROUND

Often, online and print (catalog) depictions of product colors are insufficient to render the same color as perceived by the consumer upon direct inspection of the given product. According to Invesp Inforgraphic regarding online return rates statistics, at least 30% of all products ordered online are returned compared to only 8.89% bought in brick-and-mortar shops (https://www.business2community.com/infographics/e-commerce-product-return-statistics-trends-infographic-01505394). Some significant contribution to these returns in the case of apparel and shoes are product colors that are deemed unsatisfactory by the consumer.

Currently, domestic shopping through online retail stores comprises only about 10 percent of consumer activity, but this percentage is slated to increase in the coming years. For consumers making online purchases, one of the key product features that could benefit from improved specification is color. This capability would extend to product sales on Ebay or Etsy wherein the general public could determine an item's color for posting with the item for sale.

In addition to the problem of accurate reproduction of product colors for the consumer, it remains challenging for the consumer to match the color of an advertised product to the color of an item in the consumer's possession. Many variables contribute to the difficulty in high fidelity reproduction of color as well as in color matching. Among these are:
Variable illumination
Observation angle
Observer metamerism
Spectral matching versus colorimetric matching—lack of spectral resolution
Background
Textures
Temperatures

Hence, it would be advantageous for a method and associated system that would overcome these issues and present a high fidelity remote representation of the true product color. Foundational to development of such technology is an assessment of the details concerning how color is defined and perceived by humans.

### Quantifying Color

The classical descriptive mechanism for accurately defining the relationship between the wavelength(s) of a color and the perceived effect on the human eye is a color space. This construct also permits color comparisons between displays that exhibit different ways they display color, i.e. color profiles.

### Color Spaces

Color descriptions are predicated on either additive or subtractive color theory; the former for transmitted light (ex. electronic displays) the latter for reflected light (printed materials and paints).

A color space describes an abstract, multidimensional environment in which any particular color can be defined. A color model is a geometric or mathematical framework that attempts to describe the colors humans perceive. It uses numerical values pinned to dimensions of the model to represent the visible spectrum of color. A color model provides a method for describing, classifying, comparing, and ordering colors.

Further, a color space is a practical adaptation of a color model that specifies a gamut of colors that can be produced using that model. The color model determines the relationship between values, and the color space defines the absolute meaning of those values as colors. These values, called components, are in most instances floating-point values between 0.0 and 1.0 (Introduction to Color Programming Topics for Cocoa, Apple Programming Guide).

There are five major color models or spaces that sub-divide into others, these are: CIE, RGB, YUV, HSL/HSV, and CMYK; the latter being a subtractive color model applicable to printing. These standardized color description systems are used to quantify color and permit consistent production of print, paint, and video display colors. Transformation among these different color spaces is achievable mathematically (Adrian Ford and Alan Roberts, Color Space Conversions, Aug. 11, 1998, http://www.wmin.ac.uk/ITRG/docs/coloreq.html, page 1-31.).

Reference is made to FIG. 1, which depicts the 1931 CIE (Commission internationale de I'eclairage) Chromaticity diagram as a representation of a color space encompassing all humanly discernable colors.

The XYZ chromaticity diagram is a standard color space, independent of any choice of primaries, in which the color of any object or light can be specified, independent of its total reflectance or brightness. The horseshoe-shaped perimeter of this space corresponds to all saturated colors, i.e. single wavelength (pure) colors. It can be said that as a trajectory is traced inward from these perimeter coordinates, the effective optical bandwidth of the light represented by the coordinates increases and becomes unsaturated (impure). In accordance with Grassman's Laws of Additive Color Mixture, primary colors selected on this diagram establish a polygon wherein any color enclosed in the respective polygon can be generated with the appropriate intensity weighted combination of the primary colors. The space of colors that can be synthesized by a set of primary colors is called the gamut.

FIG. 2 depicts the color gamut spanned enclosed by the dotted triangle 1, using red 5, green 3, and blue 7 primary colors inherent is various display and reflective systems. FIG. 3 depicts expansion of the color gamut 11 through use of a greater plurality of primaries, 13, 15, 17, 19, and 21. Again, it should be emphasized that primaries whose coordinates are located on the perimeter of the chromaticity diagram are single wavelength (fully saturated). Such saturated primary could be approximated by laser sources with very narrow bandwidths. As the primary coordinates of a primary approach the center of the diagram they are of increasing optical bandwidth (unsaturated). The very center of the diagram represents the most unsaturated color—white, encompassing all visible wavelengths.

### Visual Response

In the XYZ color space, the Y coordinate represents luminance (measured intensity). It is useful to transform this space to an Yxy color space in which the Y coordinate remains representative of luminance, x represents hue, and y represents saturation.

XYZ tristimulus values and the associated Yxy color space form the foundation of present CIE color spaces which are widely used for color comparison. The concept for the XYZ tristimulus values is based on the three-component theory of color vision, which states that the eye possesses receptors for three primary colors (red, green, and blue) and that all colors are seen as mixtures of these three primary colors. The XYZ tristimulus values are calculated using these CIE Standard Observer color matching functions (CMFs))x̅(λ), y̅(λ), ż(λ), as depicted in the FIG. 4.

These functions represent the spectral response (across the visible spectrum from 380 nm to 780 nm) of the three types of cone photoreceptors in the eye and have been generated as an ensemble average across a population of individuals.

The Commission International de I'Eclairage (CIE) has documented CMFs for two different categories of standard observers: a 2 degree 1931 CIE standard observer and a 10 degree 1964 CIE standard observer. These matching functions are ensemble averages across a population of normal observers using viewing conditions that vary emphasis on the foveal response. In FIG. 5, a plot of RGB CMFs, the variation of response from observer to observer is illustrated by the spread in response across a particular ensemble of 49 observers. (Stiles, W. S., & Burch, J. M., “NPL color-matching investigation: Final report”, Optica Acta, 6, 1-26, 1959.)

The Yxy encoding is a very good solution due to its strong physical/perceptual background. One can go from RGB color space to XYZ (selecting a certain color-space transform matrix), and then go from XYZ to Yxy using the following formulas:

$$x = X / ( X + Y + Z )$$

$$y = Y / ( X + Y + Z )$$

$$X = K {\int }_{380}^{780} S ( λ ) \overline{x} ( λ ) R ( λ ) d λ$$

$$Y = K {\int }_{380}^{780} S ( λ ) \overline{y} ( λ ) R ( λ ) d λ$$

$$Z = K {\int }_{380}^{780} S ( λ ) \overline{z} ( λ ) R ( λ ) d λ$$

$$K = \frac{100}{{\int }_{380}^{780} S ( λ ) \overline{y} ( λ ) R ( λ ) d λ}$$

Where S(λ): Relative spectral power distribution of the illuminator
x̅(λ), y̅(λ), z̅(λ): Color-matching functions for CIE 2° Standard Observer (1931)
R(λ): Spectral reflectance of specimen

The CIE chromaticity diagram is generated by plotting the average CMFs in the x,y coordinates. In the Yxy color space, Y remains the luminance and independent of luminance, the x and y coordinates represent hue and saturation respectively. Other color spaces have been defined that are linear transformations of the CIE 1931 color space. For quantifying color differences, a more uniform color space with u′, v′ coordinates was derived; in the associated coordinates Δu′v′≤0.002 is assessed as change that is visually undiscernible to humans.

While the 1931 x, y chromaticity diagram is accepted and used widely in the field of color science, there are a few fundamental flaws. One of the major problems is the non-uniformity of the diagram. A certain geometric distance in, for example, the green part of the diagram does not represent an equal perceived difference in color as the same distance does in the blue part of the diagram. In 1942, MacAdam (MacAdam, D. L., “Visual Sensitivities to Color Differences in Daylight”, Journal of the Optical Society of America, 32(5), 247, 1942.) did a series of color matching experiments to determine the just noticeable differences (JND) of chromaticity. MacAdam shows the resulting JND plotted in the x, y color space are in fact ellipses with widely varying size depending on their location in the chromaticity diagram. In FIG. 6, these ellipses are plotted in the x,y color space, but enlarged 10 times for ease of viewing. It is apparent that perceivable color differences and geometrical distances between color coordinates depend on the location in the diagram itself (W. Hertog, “The design and implementation of a spectrally tunable LED-based light source: towards a new era of intelligent illumination”, PhD Thesis, Department of Optics and Optometry of the Universitat Politècnica de Catalunya, December 2016).

To achieve a sense of human visual sensitivity to wavelength changes across the visible spectrum, reference is made to FIG. 7. This is a plot of JNDs in color across the visible spectrum for saturated light (Krudy A, Ladunga K, “Measuring wavelength discrimination threshold along the entire visible spectrum”, Period Polytech Mech Eng 45, 2001, pp. 41-48.). It is apparent that variation in wavelength between light sources as small as 2 nm can be detected.

In quantizing the intensity of lighting, gamma encoding of images is used to optimize the usage of bits when encoding an image, or bandwidth used to transport an image, by taking advantage of the non-linear manner in which humans perceive light and color. The human perception of brightness, under common illumination conditions (not extremes), follows an approximate exponential power function with greater sensitivity to relative differences between darker tones than between lighter ones, consistent with the Stevens' power law for brightness perception. If images are not gamma-encoded, they allocate too many bits or too much bandwidth to highlights that humans cannot differentiate, and too few bits or too little bandwidth to shadow values that humans are sensitive to and would require more bits/bandwidth to maintain the same visual quality. Gamma encoding of floating-point images is not required (and may be counterproductive), because the floating-point format already provides a piecewise linear approximation of a logarithmic curve. In the present application that involves single pixel display for color matching, gamma encoding is not required.

It is important to recognize that color perception is a psycho-visual phenomenon . . . so certain viewing conditions must be under control to achieve consistent color reproduction at the stage of human perception.

### Metamerism

Two or more stimuli having identical chromaticity coordinates, but a different spectrum, are called metamers. The stimuli can be either light sources or objects reflecting or transmitting a certain illumination spectrum. Metamerism exists because the retinal cones are tristimulus receptors, which means that for one set of chromaticity coordinates there are an infinite number of matching spectra. Metameric failure occurs when a change of the illuminant spectrum, the observer, the field-of-view or the angle-of-view causes a change in color coordinates (W. Hertog, “The design and implementation of a spectrally tunable LED-based light source: towards a new era of intelligent illumination”, PhD Thesis, Department of Optics and Optometry of the Universitat Politècnica de Catalunya, December 2016).

Illuminant metameric failure—Occurs when a change in the illuminant causes a difference in chromaticity between two items viewed under that light source.

Observer metameric failure—Observer metameric failure is caused by the difference in the visual system between 2 observers. Color perception among color normal observers varies depending on pre-retinal filtering in the optical media (cornea, lens, and humors), macular photo pigment density, cone distribution differences, color neural processing differences, and differences in cone spectral sensitivity. This cause of metamerism is underscored by reference to FIG. 5 depicting the variation in CMFs across multiple observers.

Field-of-view metameric failure—When a stimulus is viewed with the central fovea, due to a difference in concentration in cones, the color sensation is slightly different than when the same stimulus is registered outside the central foveal region of the retina.

Angle-of-view metameric failure—Depending on the gloss and other gonio-dependant characteristics of certain materials, the chromaticity changes depending on the viewing angle.

Given control over the color reproduction environment in the currently disclosed method and system, the two forms of metamerism considered most important are illuminant and observer metamerism. Approaches to mitigation of metamerism are addressed below in the Detailed Description.

### Color Gamut Limitations

Some product colors cannot be rendered on conventional RGB displays given that the product color spectrum resides outside the gamut of the display. Also, printer gamuts are considerably smaller than display gamuts; hence, the inherent limitation in print catalog representations of product colors.

### PRIOR ART

Relevant prior art includes optical spectral sensors, color displays, and color matching methodologies.

### Sensors

Optical instruments used to measure color include spectrometers and colorimeters. Spectrometers measure the continuum spectrum of light being sensed, whereas colorimeters typically are designed to output the light intensity captured by RGB CMFs (Most often, standard CMFs are used.)

In a spectrometer, light is either refracted or diffracted to spatially distribute the different wavelengths of a light source (whether reflected or emitted) across a detector array, whereby the intensity of light at a particular wavelength (or small spread of wavelengths) is captured on a single detector. In this way the continuum spectrum of the given light is measured. Spectrometric measurement is divorced from the issues surrounding human perception of color and any associated ambiguities (such as metamerism) because the entire color spectrum is measured. Colorimeters use calibrated illumination and color filters that mimic the spectral profile of human CMFs to provide three (RGB) integrated color values.

Colorimeters such as Color Muse, Nix Mini Color Sensor, and models by X-rite have been marketed to consumers for color matching applications. The following features are advertised for Color Muse:
Built in illumination source
Constant illumination and viewing angle
Constant “observer”
Elimination of area effect and contrast effect
Color difference measurement

However, in the present application, spectrometers are the favored color measurement device in order to avoid observer metamerism. High end spectrometers exhibit exquisite spectral resolution, but lower cost devices can be used to achieve spectral resolution on the order of a nanometer.

Optical detectors of importance include integrated multi-spectral sensors, most notably, those vended by Austria Micro Systems (AMS) (previously manufactured by MAZeT GmbH). These sensors are fabricated from multiple dielectric filters rendered in a single miniature package with electronic interface. Such devices are useful for closed-loop wavelength control of LEDs.

### Displays

Color display displays include commercial solid state devices such as those associated with smartphones, tablet computers, and monitors for computer, entertainment, and industrial applications. Also, luminaire technology used for colored light illumination is relevant. Important considerations are the number and saturation level of the primaries used in the display as this will determine the color gamut that can be displayed. The core LED technology underpinning many of these display devices is of paramount importance. Among critical LED parameters are optical bandwidths, wavelength availability and stability with temperature and drive current, and flux levels. Significant performance improvements in LED and associated LCD technology have occurred in recent years.

### Color Matching Methods

Prior art additive color matching methods are most relevant to the present application given the emphasis on active display of reproduced color. In this context, the many variants of color monitor calibration used in work flow protocols within the graphic arts and publishing industries are important. Many of these methods involve software hosted on monitors that is used in concert with colorimeters or spectrometers. Characterization of color reproduction devices is achieved with device profiles; exemplary is U.S. Pat. No. 8,246,408.

The most widely used profiles are those of the International Color Consortium (ICC). These permit correct color reproduction when images are input from a scanner or camera and displayed on a monitor or printed. They define the relationship between the digital representations of color information the device receives or transmits and a standard color space defined by ICC and based on a measurement system defined internationally by CIE. Thus, a profile can be available for a scanner, camera, display and printer; the fact that they refer to a standard color space permits their combination in a workflow so that the correct color is maintained from imaging to display or printing.

An ICC profile is one that conforms to the ICC specification. By conforming to this specification profiles may be exchanged and correctly interpreted by other users. The two main types of profiles are source (input) and destination (output) profiles and essentially consist of tables of data that relate the device chromaticity co-ordinates to those of the standard color space defined by ICC. There are various relationships defined in each profile (known as rendering intents). Special types of profiles (devicelink, and abstract) are defined for special workflow applications.

### Metamerism Reduction

Various prior art methods of reducing observer metamerism can be cited, among these include increasing the bandwidth of primaries, selecting specific red, green, and blue wavelengths, use of more than three primaries, and a method for observer-dependent color imaging wherein the color workflow is tuned to match one of several observer classes. In the latter case means to assign an observer to such classes can be physiologically based. Noteworthy is U. S. Patent Application 20140028698 which discloses applying a metamerism correction transform to a input color image to determine an output color image in an output color space appropriate for display on the color display device, the output color image having a plurality of output color channels, each of the output color channels being associated with one of the device color primaries, wherein the metamerism correction transform modifies colorimetry associated with the input colors to provide output color values such that an average observer metameric failure is reduced for a distribution of target observers.

### SUMMARY OF THE INVENTION

There are well developed technologies that can be used to specify colors in quantitative fashion and reproduce such colors by active display means. For color measurement and quantification, spectrometers or colorimeters can generate a quantitative, reproducible description of any particular color when observed under controlled illumination. In the spectrally accurate display of color, illumination sources such as LEDs and OLEDs can provide display primaries for additive color synthesis that can be wavelength controlled.

What is needed is a viable, cost effective, convenient method for remote color reproduction and matching that can be used by product vendors and consumers. More particularly, to be sought is a method and system that permits color identification and matching for items or products that are not locally observable by an interested party. Presently disclosed is a business method and system to achieve these objectives. The method involves actions taken by both product vendor and consumer. In this method, the vendor will use a sensor to capture product spectral color information under controlled illumination conditions. This spectral information would be communicated with prospective consumers. Such information can be digitized and coded for publication online or in printed material associated with the given product. The consumer would either upload this information into a compact display that would provide a high fidelity rendering of the actual product color or could use a display (smartphone, tablet, or monitor) calibrated to the consumer's visual response. Variations on this method include different approaches to mitigate observer metamerism which otherwise would cause failure to render colors with adequate fidelity for the individual consumer.

A first such approach to diminish observer metamerism comprises the calibration of displays to be used by the consumer for product color reproduction. Such calibration would be performed against measured user CMFs. A second approach makes use of a multi-primary display exhibiting spectral match to the product spectrum under colorimetric constraints. The colorimetric constraint comprises either a match to standard CMFs, such as CIE 1931 CMFs, or to the measured consumer CMFs.

The system to support implementation of this method, comprises a spectral sensor to be used by the vendor in the form of a colorimeter or spectrometer with digital output, and a portable display used by the consumer to render the product spectral color information published by the vendor.

The consumer display can be a smartphone, color tablet, color monitor, or, in the case of a preferred embodiment, a compact, handheld monocular or binocular device, after the fashion of a virtual reality headset. This latter device uses several illumination primaries to reproduce the color spectrum of the product. By blocking ambient light, this latter device, would eliminate color perception issues associated with ambient and background light. Additionally, as stated, some embodiments of the method require measurement of the consumer's CMFs. The functionality to perform such measurements can be instantiated as a standalone compact portable device or can be incorporated into the aforementioned monocular or binocular display device.

Below is a lexicon of terms used in this disclosure to support the meaning of the specification and to clarify interpretation of the appended claims.

### Definitions

colorimetric matching constraint—when optimizing a match of the product spectrum to the light from a combination of multi-wavelength primaries this constraint is applied to also drive a best match to the outputs from CMFs, either average observer CMFs or the measured consumer CMFs (a consumer CMF colorimetric matching constraint)

color associated with the composite spectrum—the color that is produced by a display using mixing ratios for the primaries that have been calculated to generate a match to a product composite spectrum

color associated with the filtered spectrum—the color that is produced by a display using primary mixing ratios to match the product spectrum that has been filtered with the consumer's CMFs

color checker—is an array of scientifically prepared colored squares in a wide range of colors that span the visible spectrum and that represent the range of natural objects encountered in the world—when placed in a scene they can be used to color calibrate display of the photographed scene on any given display

color mixer—a device which combines radiation from sources of having different center wavelengths so as to create a light field of spatially uniform color

consumer—a user who is interested in identifying the color of a product for sale online or in printed pictures as they would perceive the physical item, also refers to a consumer of color information

consumer's illumination spectrum—the spectrum of ambient or directed light used to illuminate articles in the consumer's environment

custom RGB display—a handheld display useful for displaying color using RGB primaries

display in high fidelity—a quality of remote color display that reproduces the product color sufficiently closely that normal observers would consider that the reproduced color matches the original

ensemble of advertised products—a sample of products that would be advertised online or in video or print media sufficiently large to represent the gamut of colors that need to be reproduced for consumers

illumination type—one of the standard illumination spectra, such as D65

local—characterizing an item that can be viewed directly by the party interested in the item's color

pattern color map—a spatial mapping of the color code descriptors that compose a color pattern and can be used to display the color pattern

primaries—the set of three or more disparate wavelength optical sources used to compose a given color

publishing spectral information in a form for consumer use—electronic or print publication of either spectral data or corresponding primary mixing levels for consumer use in display of product color

remote—characterizing an item that is not local to the party interested in observing the item's color

remote reproduction—high fidelity reproduction of an article or product color at a location remote to the article or product

RGB—red, blue, green

Single pixel and single pixel data—refers to the single color of the product and the single colors of the color checker colors, not associated with an image. A single pixel of color can be expanded to multiple pixels in color calibration software for human visual interaction and still be considered “single pixel” to emphasize the non-imaging nature of the color reproduction or matching method.

standard CMFs (color matching functions)—any one of a number of standard CMFs for normal observers such as CIE 1931 or CIE 1964

spectral information—information about an article or product color that comprises actual spectra, associated tristimulus values, amplitudes of a set of multi-primary LED intensities optimized to match the article spectrum, encoded spectral information, and ambient or illumination spectra

spectral match of the multi-primary display—calculating the mixing ratios for the LEDs of a multi-primary display to optimally match a color spectrum

total spectrum or composite spectrum—the spectrum resulting from the wavelength-by-wavelength multiplication of the product reflection spectrum and an illumination spectrum—the illumination spectrum could be that used to illuminate the product or the consumer's lighting spectrum

true color—color rendering of the product or article that exhibits a spectrum that is acceptably close to the actual product reflectivity spectrum or total spectrum

user—a person(s) who would be in receipt of a product color description code or information, wishing to view the associated color

vendor—an entity selling a given product online or through printed description, also refers to a provider of color information

### DESCRIPTION OF THE FIGURES

FIG. 1 is a plot of the CIE chromaticity diagram.

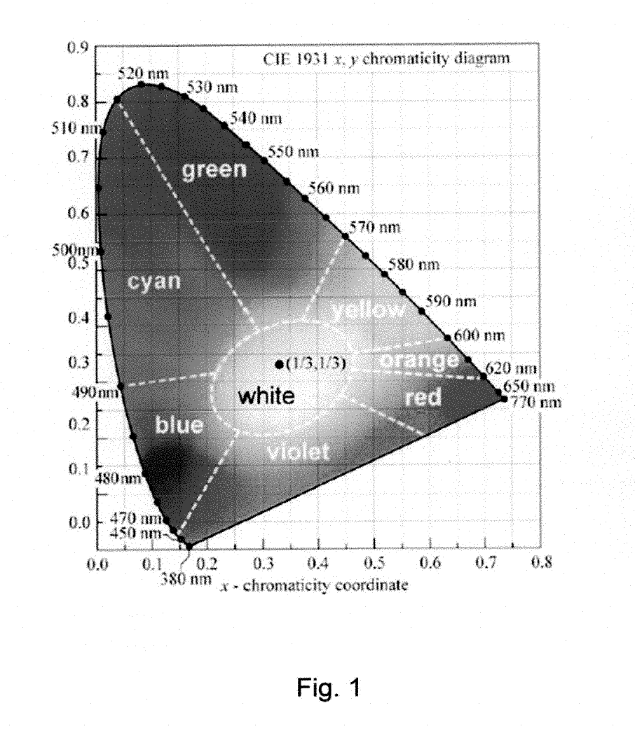

FIG. 2 is a plot of a three-primary gamut on the CIE chromaticity diagram.

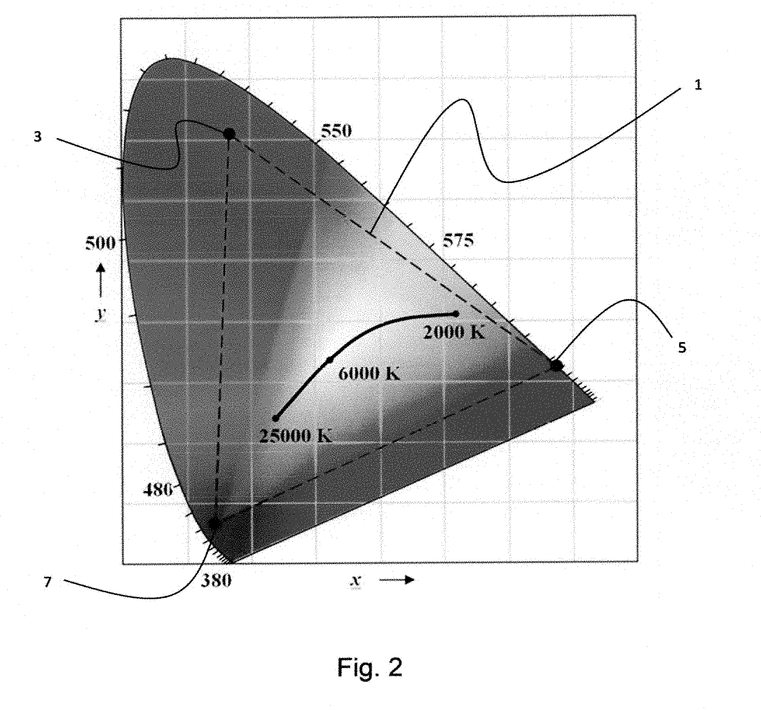

FIG. 3 is a plot of a five-primary gamut on the CIE chromaticity diagram.

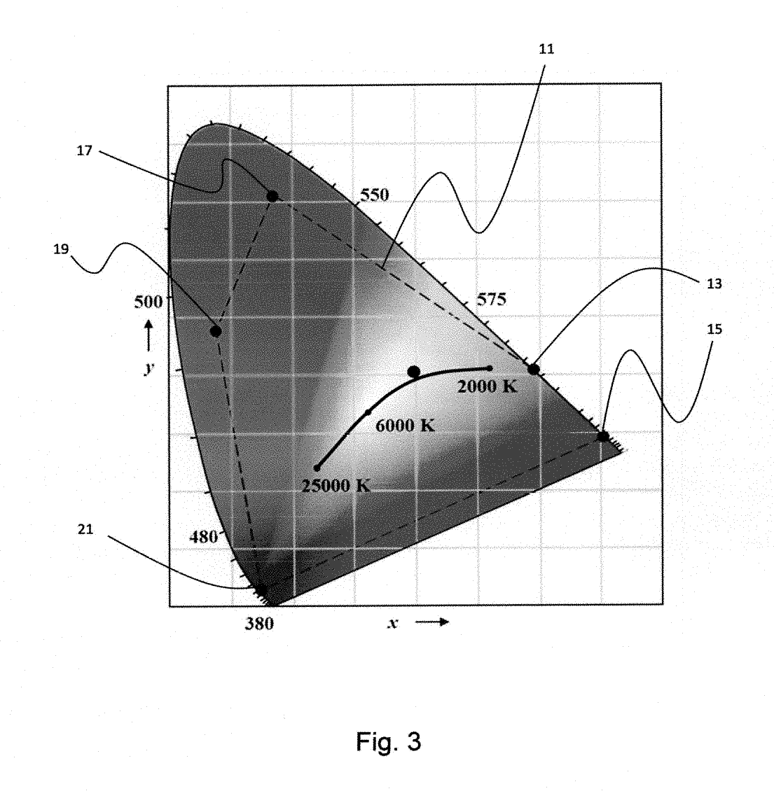

FIG. 4 is a plot of the three CIE CMFs.

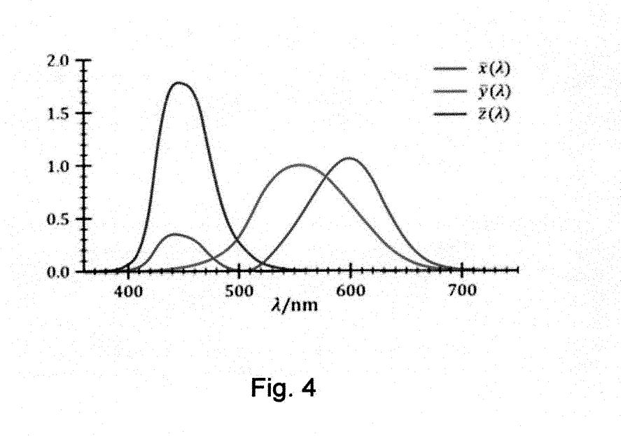

FIG. 5 is a plot of the spread in RGB CMFs among multiple standard observers.

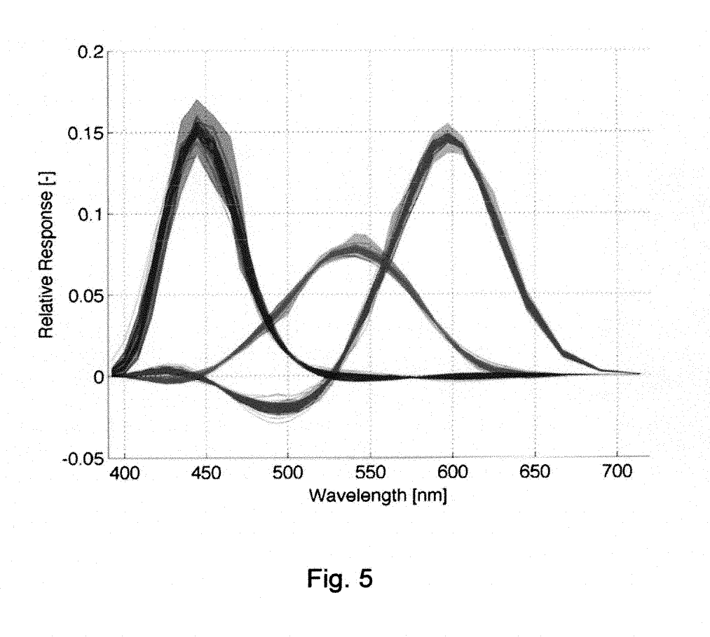

FIG. 6 is a plot of MacAdam ellipses on the CIE chromaticity diagram.

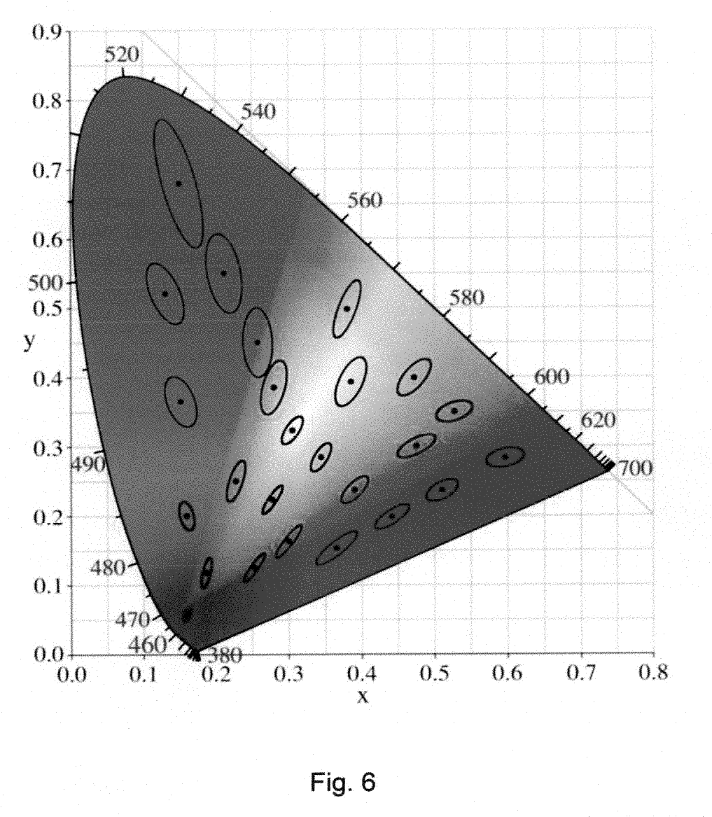

FIG. 7 is a plot of the just noticeable wavelength difference across the visible spectrum.

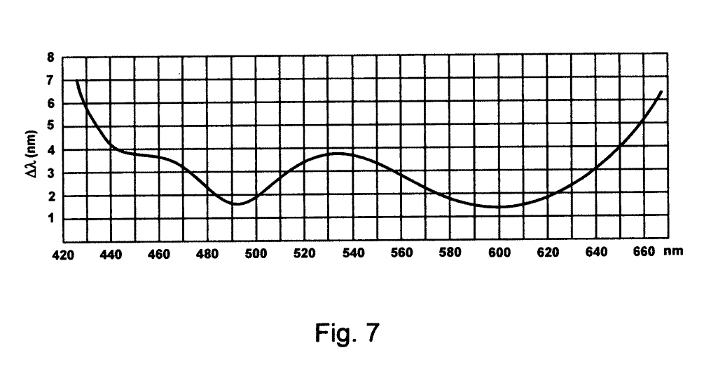

FIG. 8 is the spectral plot of primaries at eight specific wavelengths that can be used to minimize observer metamerism.

FIG. 9 is a pictorial view of a color reproduction display device for consumer use.

FIG. 10 is schematic and functional diagram of the control circuitry for a multi-primary display used for color reproduction.

FIG. 11 is a schematic and functional diagram of a color reproduction display system including color matching function measurement capability.

### DETAILED DESCRIPTION OF THE INVENTION

The method and system of the present disclosure requires the functions of product spectral measurement, calculation of mixing ratios for the primaries of a display to reproduce the color, and implementation of spatial color mixing of the display primaries.

### Measuring the Spectrum of the Product Color

There are nuances surrounding the capture of product color spectral information, some of these are not considerations in the case of narrow field of view light capture, without background reflections. Nevertheless, the diffuse and specular components of product reflectivity must be addressed. The spectrum capture should be along a normal to the local surface of the product and there should be not shadowing due to product geometry.

There are two modes of product spectrum measurement in the present color reproduction method. In the first mode, the total product spectrum is measured by the product vendor to include the result of both illumination and reflection. In the second mode, there are two instances of illumination spectrum measurement: a) the illumination spectrum is specially measured by the product vendor or an adopted standard is adequately implemented, and b) the illumination spectrum in the environment of the consumer is measured. This second mode is intended for use in mitigating illuminant metamerism.

The table below summarizes standard illumination spectra. The prevailing industry guidance is that CIE standard illuminant D65 should be used in all colorimetric calculations requiring representative daylight. It is advisable that at least two other instances of illuminants be used, perhaps one each for incandescent light and fluorescent light, respectively. Which illuminants to use should become an industry standard for the present method.

| | |
|---|---|
| CIE Standard | |
| Illuminants | Description |

First three standard illuminants - introduced in 1931

| | |
|---|---|
| A | Incandescent light with a correlated color temperature of |
| | 2856 K |
| B | Representative of noon sunlight, with a correlated color |
| | temperature of 4874 K |
| C | Average daylight (not including ultraviolet wavelength |
| | region) with a correlated color temperature of 6774 K |

D series (Natural Daylight)

| | |
|---|---|
| D50 | Representation of a phase of daylight at a correlated color |
| | temperature of 5000 K |
| D55 | Representation of a phase of daylight at a correlated color |
| | temperature of approximately 5500 K |
| D65 | Intended to represent average daylight and has a |
| | correlated color temperature of approximately 6500 K |

F series (Fluorescent Lighting)

| | |
|---|---|
| F1-F6 | Spectra for “standard” fluorescent lamps consisting |
| | of two semi-broadband emissions of antimony and |
| | manganese activations in calcium halophosphate |
| | phosphor |
| F7-F9 | “Broadband” (full-spectrum light) fluorescent lamps with |
| | multiple phosphors, and higher CRIs |
| F10-F12 | Narrow triband illuminants consisting of three |
| | “narrowband” emissions (caused by ternary compositions |
| | of rare-earth phosphors) in the R, G, B regions of the |
| | visible spectrum |

### First Mode of Product Spectrum Measurement

Having measured the product color spectrum that includes illumination and product reflectivity, the vendor can publish spectrum information corresponding to three different illuminants. Then, the consumer will be able to reproduce the product color as viewed under these three different lighting conditions.

### Second Mode of Product Spectrum Measurement

In this mode, the product color spectrum (that includes illumination and product reflectivity) and the illumination spectrum are measured by the vendor. If a standard illuminant is adequately emulated by the vendor, then the identity of the standard spectrum can be published by the vendor for use by the consumer. Since the total spectrum comprises the product of the illuminant amplitude and reflectivity amplitude at each wavelength, the reflectivity spectrum can be derived.

The problem of separating illumination and reflectance spectra has been addressed in image and machine vision applications, which involve pixel-by-pixel separations. This has included the issue of spatially non-uniform illumination. (Xiaochuan Chen, Mark S. Drew, and Ze-Nian Li, “Illumination and Reflectance Spectra Separation of Hyperspectral Image Data under Multiple Illumination Conditions”, Electronic Imaging 2017: Color Imaging XXII, Displaying, Processing, Hardcopy, and Applications, 29 Jan.-2 Feb. 2017, San Francisco.) Hence, a host of prior art algorithmic approaches to this problem exist. Fortunately, the present application largely involves the degenerate case of uniform illumination and a scalar (single pixel) color signal. Prior art offers a number of ways to optimally estimate the reflectivity at wavelengths where the total spectrum signal-to-noise-ratio is poor. For a product of uniform color, light from only a small region of the product surface needs to undergo spectral measurement. In the case of products exhibiting variable color, uniform color regions of the product should be independently measured.

In order to reproduce the product color as would be observed in the consumer's environment, the ambient light or illumination spectrum present in the consumer's environment must be measured. Then it can be multiplied by the product reflectance spectra published by the vendor to create the total spectrum that would be observed in this environment. Hence, there is need for a low cost spectrometer that would be used by the consumer in the presently disclosed method and system. Fortunately, do-it-yourself spectrometers with sub nanometer wavelength resolution (able to separate the Sodium-D lines) can be made very inexpensively. Examples use gratings comprising DVD material or grating films and a webcam detector. This technology can be incorporated into the color reproduction display device discussed below.

### Lighting Conditions

As is well known in the prior art associated with product photography, guidance exists for optimal color photography of articles to include approaches to the use of fill or bounce light to soften shadows and choice of surrounding illumination environment. Emphasis in the presently disclosed method and system is to capture a small field of view that does not exhibit shadowing. However, some convex surfaces and textures may require such attention.

### Generation of Amplitudes for a Multi-Primary Display

As discussed below, one approach to minimizing observer metamerism involves use of a multi-primary display with LED wavelengths determined by optimization calculations. To determine the relative intensities of these LEDs that best match the measured product spectrum, the method of Murakami et al (Yuri Murakami, Jun-ichiro Ishii, Takashi Obi, Masahiro Yamaguchi, Nagaaki Ohyama, “Color conversion method for multi-primary display for spectral color reproduction”, J ELECTRON IMAGING, vol. 13, 30 Sep. 2004, pp. 701-708.) is employed.

The method gives the amplitude values of each primary of a multi-primary display device that minimize the spectral approximation error under the constraints of tristimulus match. The constraint used in the conversion is a tristimulus match for the standard observer, which is the same constraint for the conventional color reproduction. Under this constraint, this method does not need any information about the individual CMFs or deviations to minimize the difference between the spectra of the original object and the reproduced light.

If the color generation of an N-primary display is based on the additive mixture of the primaries, the spectral intensity of the reproduced light P(λ) is approximately represented by

$$P ( λ ) = {\sum }_{j = 1}^{N} {α}_{j} {p}_{j} ( λ ) ,$$

where Pⱼ(λ) (j=1, . . . , N) is the spectral intensity of the full-emitted jth primary light and αⱼ(0≤αⱼ≤1) is the amplitude of the jth primary. If S(λ) is the spectral intensity reflected from the article for which color reproduction is desired, then the square error between S(λ) and the reproduced spectrum by the N-primary display is defined as

E=∫[S(λ)−P(λ)]²dλ.

The method determines the set of primary amplitudes {α₁, . . . , α_{N}} that minimizes E. When minimizing E, the constraints that the tristimulus values of the CIE standard observer are accurately reproduced are imposed. That is

∫tₖ(λ)S(λ)dλ=∫tₖ(λ)P(λ)dλ,k=X,Y,Z,

Where tₖ(λ) are the CMFs of the CIE standard observer. These constraints are introduced because of the following reasons. If a set of primary amplitudes is optimized only for spectral approximation, the tristimulus errors for most observers can be considerably large, especially when the number of the primaries is insufficient. To reduce the average mismatch, tristimulus match for the CIE standard observer is effective because CIE standard CMFs are designed to represent the average color matching response of the population of human observers. The algorithmic solution to this optimization problem is found in the above reference to Murikami et al, which is incorporated herein by reference. Software to calculate the optimization solution is hosted on a computing platform for the vendor. These optimization results, in the form of relative LED amplitudes for either product total spectrum or reflection spectrum, can be published by the vendor for consumer use in the corresponding multi-primary display.

### Color Mixing Optics

The presently disclosed method and system require means to create a uniform color display from a plurality of LEDs of different wavelengths. The uniformity of such color mixing must be sufficient that color variation is not detectable within the observer's field of view.

Great impetus for achieving good color homogeneity in multi-wavelength light mixing comes from the commercial lighting industry and luminaire product development. Initial approaches to color mixing from multiple LED sources simply relied upon use of textured surfaces, or diffusers for spreading of light. Often expensive optics with high numerical apertures are required to collect the spread light. Further, the efficiency and performance of such systems are inferior to newer approaches that involve light guiding. These latter designs typically have been optimized by simulation with Zemax or similar optical modeling software.

Many patents have been issued on the subject of color mixing and homogenization for LED sources. U.S. Pat. No. 9,746,596 is exemplary of methods that use molded optics and light pipe geometries. Also, commercially available optics have been developed for LED color mixing. Examples include high efficiency molded polymer lenses for RGBW LED color mixing from Khatod, Milano, Italy (part number PL1590ME).

The most effective and compact implementations of color mixers that achieve spatially homogeneous color and intensity use a combination of light pipes, refractive and reflective interface geometries, and diffusion. An example (Sun, C. C.; Moreno, I.; Lo, Y. C.; Chiu, B. C.; Chien, W. T. Collimating lamp with well color mixing of red/green/blue LEDs. Opt. Express 2012, 20, A75-A84) is a compact optical system for RGB color mixing that demonstrates use of only compact monotonic surfaces in the optical design. It comprises a relatively short (less than 10 millimeters length), straight lightpipe with silver scatter sheet reflective walls, a volume scattering diffuser, and a total internal reflection (TIR) output lens. A luminaire design for a larger number of multi-wavelength LEDs (Maumita Chakrabarti, Henrik Chresten Pedersen, Paul Michael Petersen, Christian Poulsen, Peter Behrensdorff Poulsen, Carsten Dam-Hansen, “High-flux focusable color-tunable and efficient white-light-emitting diode light engine for stage lighting”, Optical Engineering 55 (8), August, 2016.) demonstrates a departure from color uniformity over a few degrees viewing angle of less than 0.001 percent. It exploits a microlens array, a parabolic reflecting surface, and a TIR lens.

Another approach which entails using freeform optics to map out light ray trajectories is exemplified by the design of Chen et al. (Enguo Chen, Rengmao Wu, Tailiang Guo, “Design a freeform microlens array module for any arbitrary-shape collimated beam shaping and color mixing”, Optics Communications, Volume 321, 15 Jun. 2014, Pages 78-85.) This freeform microlens array module, which shows better flexibility and practicality than the regular designs, can be used not only to reshape any arbitrary-shape collimated beam (or a collimated beam integrated with several sub-collimated beams), but also most importantly to achieve color mixing.

A novel mixing approach is detailed in U.S. Pat. No. 9,022,598 which discloses combining the zero spatial frequency components of colored sources to achieve homogenization of composite color. The invention exploits the fact that extended and non-overlapping light emitting sources arranged in a specific pattern may overlap in Fourier space.

Finally, multi-wavelength beam combining can be achieved with consecutive introduction of each color beam into the composite beam using multiple dichroic filters like the LaserMUX™ filters manufactured by Semrock. However, this approach is relatively expensive.

Light guiding techniques are most adaptable to the display concept of the present disclosure and support the fabrication of a compact, handheld display device as described in more detail below. In fact, the same method of LED color mixing can be used for both rendering of colors necessary for measurement of consumer CMFs and in the final multi-primary display of reproduced product color.

### A Preferred Implementation of Color Mixing

An adaptation of the aforementioned concepts that permits color mixing of as many as 8 different wavelength LEDs in a compact geometry can employ light guiding, with volumetric and surface scattering, and appropriately designed refraction and reflection to obtain color display that exhibits imperceptible nonuniformity.

### Measuring Individual CMFs

Fedutina et al. (M. Fedutina, A. Sarkar, P. Urban, P. Morvan, “(How) Do observer categories based on CMFs affect the perception of small color differences?”, Color and Imaging Conference 2011 (1), pp. 2-7.) demonstrated in nine categories of observers based on color perception metrics, significant departure of the individual response from the CIE standard observer. The determination an individual's CMFs can be paramount in achieving color matches below the threshold of difference detection.

### Methods of Measuring CMFs

Various methods of measuring the consumer's CMFs delineated herein are within the scope of the present invention. The most commonly used approach is the maximum saturation method, which was used by Wright (Wright, W. D., “A re-determination of the trichromatic coefficients of the spectral colours”, Transactions of the Optical Society. 30:141-164, 1929.) and Guild (Guild, J. 1932. The colorimetric properties of the spectrum. Philosophical Transactions of the Royal Society of London, Series A. 230:149-187.) to obtain color matches that were subsequently used to generate the CIE 1931 CMFs. In this method, the observer is presented with a half field illuminated by a “test” light of variable wavelength, A, and a second half field illuminated by a mixture of red (R), green (G) and blue (B) primary lights. At each A, the observer adjusts the intensities of the three primary lights, so that the test field is perfectly matched by the mixture of primary lights.

In Maxwell's method, preferred for the present application, the matched fields always appear white, so that at the match point, the eye is always in the same state of adaptation whatever the test wavelength (in contrast to the maximum saturation method in which the chromaticity of the match varies with wavelength). In a matching experiment, the subject is first presented with a white standard half field, and is asked to match it with the three primary lights. The test light then replaces the primary light to which it is most similar and the match is repeated.

### Fitting Data to Parametric Models

In the work of Asano et al. (Yuta Asano, Mark D. Fairchild, and Laurent Blonde, “Individual Colorimetric Observer Model”, PLoS One. Feb. 10, 2016; 11(2):e0145671, eCollection), eight additional physiological parameters are added to the two parameters in the CIE 2006 Physiological Observer construct to model individual color-normal observers. These eight parameters control lens pigment density, macular pigment density, optical densities of L-, M-, and S-cone photopigments, and λₘₐₓ shifts of L-, M-, and S-cone photopigments. By identifying the variability of each physiological parameter, the model can simulate CMFs among color-normal populations using Monte Carlo simulation which is computationally intensive.

Hardware Approaches to Measurement of CMFs

A concept demonstrated in 1989 was a visual four-channel colorimeter that uses the Maxwell method (Mark Fairchild, “A novel method for the determination of CMFs”, Color Research & Application 14(3), June 1989, pp. 122-130.). It used laser lines for the three red, green, and blue primaries and a broadband spectral source comprising a tungsten-halogen lamp. The three primaries plus the spectral source illuminated one half of a bipartite field. The other half was illuminated with a daylight simulator. The three primaries were intensity modulated by acousto-optic modulators under observer control. Observers made matches using the Maxwell method for five wavelengths and simulated daylight. From the visual results, color matching function for the entire visible spectrum were estimated using a statistical model. The model assumed that CMFs are a linear transform of cone sensitivities convolved with differences in the macular pigment and amount of scattering in the crystalline lens. The five wavelengths were selected to provide estimates of the level of macular pigmentation, the level of lens scattering, and the elements in the linear transform. Nonlinear optimization was used to estimate the model parameters. This approach can be revisited with an LED implementation for the presently disclosed method and system.

With time, advances in color matching filter measurement have provided simpler, more compact, and cost-effective devices. Two foremost examples comprise devices that also use Maxwell's method. In the first example (Yasuki Yamauchi, Yasuhisa Nakano, Masatomo Kamata, Katsunori Okajima, Keiji Uchikawa, Yuri Murakami, Masahiro Yamaguchi, and Nagaaki Ohyama, “Measurement of CMFs using a digital micro-mirror device”, OSA Fall Vision Meeting, December 2003.) the system can present a test stimulus whose spectral power distribution can be arbitrarily set by adjusting the power of every monochromatic light between 400 to 700 nm with a step of 10 nm. This is realized by selectively switching a digital micro-mirror, on which the spectrally decomposed light from a diffraction grating is focused. Thirty two independent compound lights are used as a test stimulus. The observer adjusts the color of the test stimulus to match that of the reference white. A two-degree bipartite field is used to present the test and the reference stimuli.

A conventional bipartite apparatus to measure CMFs usually consists of plural optical paths; a path for a test stimulus consisted of three primaries, and that for the reference stimulus. The primaries should be presented to both optical paths, as “negative” light in the reference stimulus is sometimes required to complete color matching. Thus, the conventional apparatus should have plural light sources in each optical path and requires complicated alignments. In the second device example (Yasuki Yamauchi; Minoru Suzuki, Taka-aki Suzuk, Katsunori Okajima, “Measurement of CMFs with a compact and simple apparatus using LEDs”, OSA Fall Vision Meeting, December 2010.), so as to realize a compact apparatus to measure CMFs, the researchers developed a bipartite apparatus with time-controlled LED lights.

Specifically, they used a single light source, which consisted of plural LEDs inserted to a small integrating sphere (4″ diameter). A beam splitter was used to divide the light into two optical paths. The optical path, which was delivered to a subject, was temporally switched in alternating fashion. Its frequency was high enough for the observer not to detect the flicker of the lights. By changing the switch timing of the LEDs, it was possible to arbitrarily select any combinations of the LEDs to present in either the test or the reference stimulus area. Subjects adjusted the intensity of the test stimulus which was controlled by pulse width modulation.

The resulting device was a compact CMF-measuring apparatus that can present bipartite stimulus with a single light source by time-controlled switching and modulation of the LEDs.

An embodiment of the presently disclosed method and system involves incorporating CMF-measuring functionality. In one approach, the individual's CMFs are measured with the same device that is used to display a reproduced product or article color. The same type of LED light collection and mixing optics are used for both CMF measurement and reproduced product color display. Also, it is important to emphasize that a consumer need measure his CMFs only once.

### Implicit Measurement of CMFs

An embodiment of the presently disclosed method and system that implicitly incorporates consumer CMF information comprises vendor use of color calibrating color checkers and consumer use of a software application that exploits the color checker information for display color calibration to compensate for illumination and camera spectral effects. The display however needs to have calibration to spectral standards such as by use of a colorimeter before shifting its color response using a color checker. The aforementioned do-it-yourself spectrometer can be modified to be a tristimulus colorimeter that uses the CIE CMFs to filter raw spectra. For this, the CMFs are used in software to digitally filter the spectral data.

A popular color checker product from X-rite has the following description from their website (X-ritephoto.com):

“The ColorChecker® 24 Patch Classic target is an array of 24 scientifically prepared natural, chromatic, primary and gray scale colored squares in a wide range of colors. Many of the squares represent natural objects, such as human skin, foliage and blue sky. Since they exemplify the color of their counterparts and reflect light the same way in all parts of the visible spectrum, the squares will match the colors of representative sample natural objects under any illumination, and with any color reproduction process.”

The X-rite ColorChecker Passport product suite includes three different color patch arrays that are placed in the scene to be photographed. An associated software application uses scene images containing these color patch arrays to calibrate the photo display. This technology can be employed in the presently disclosed method and system in the following ways. In the first way, one or more images of the product are captured with the color checker patch arrays included in the image (An industry agreed-upon standard for illumination would be desirable.) Such images, preferably in an electronic form (likely involving conversion between DNG format and others) would be used by the consumer to color calibrate the consumer's display (smartphone, tablet, monitor, etc.) for correct product color reproduction by use of an automated software application.

A custom color checker array of colors can be composed based on an anticpated gamut of colors spanned by a large ensemble of products because many colors within this gamut may be more saturated than those of the natural environment. It may be necessary for creation of an industry standard as a result. In the example of wound imaging, it was demonstrated that choosing a custom array of colors that best represented the wound images in a database improved color rendition upon reproduction compared to the standard Macbeth color checker (Hazem Wannous, Sylvie Treuillet, Yves Lucas, Alamin Mansouri, Yvon Voisin, “Design of a Customized Pattern for Improving Color Constancy Across Camera and Illumination Changes”, Conference: VISAPP 2010—Proceedings of the Fifth International Conference on Computer Vision Theory and Applications, Angers, France, May 17-21, 2010—Volume 1)

Another way to employ this technology is to focus on “single pixel’ information, since a main application of the presently disclosed method and system is single color capture and reproduction. In this case, it is necessary only to include single pixels of the colors of the color checker captured under the same lighting as the product (the product color also may be represented by a single pixel). These single pixel values would be published for use by the software application for the consumer's display color calibration.

One final prospect for effectively measuring a consumer's CMFs involves using a smartphone with the display in camera viewfinder mode. An app would permit the user to adjust the viewfinder display hue(s) to match the hue(s) of the actual object, color checker, or scene being viewed through the camera. Given the spectral responsivity of the camera, the user CMFs can be determined. Other software functionality would import the vendor-provided product spectrum information and filter it with the user CMFs to display the resulting reproduced product color on the smartphone display.

### A Preferred Implementation of CMF Measurement

The approach to measurement of the consumer's CMFs favored in the presently disclosed method and system uses a time division multiplexed display of each bipartite field using the same LEDs, as discussed by Yamauchi et al. In this approach, a beam splitter splits the color mixed light into two optical paths; a test stimulus path and a reference stimulus path. Each optical path is alternately blocked off by an optical chopper. Depending on the timing of the optical chopper, only one of the test or the reference stimulus is presented to the observer. Moreover, the switching timing of the LEDs is controlled to synchronize with that of the optical paths. Therefore, it is possible to arbitrarily choose any combinations of the LEDs to be presented both to the test and to the reference stimulus area. A switching frequency of 100 Hz permitted the perception of a continuous stimulus.

For the presently disclosed concept, the optical chopper (switching function) can be accomplished by a low cost projector LCD operated as a spatial light modulator (SLM) that shutters each bipartite field independently. The consumer would adjust the individual LED intensities through pulse width modulation (PWM) control (color weighting of LEDs is achieved in the multi-primary display by PWM also). Processing means included in the CMF measuring device support Maxwell's method of measurement.

The CMF measurement device can be standalone or preferably made part of the product color reproduction display. In the latter case, the CMF measurement LEDs can be a subset of those used in the multi-primary display or additional LEDs exhibiting other wavelengths. In a monocular display, the visual field is partitioned when the display device is in CMF measurement mode. For multi-primary display of reproduced product color, the full monocular field would not be partitioned.

### Implementation of a Product Color Reproduction Display

In a favored embodiment of the presently disclosed method and system, optimum choice of LEDs is paramount for achieving color reproduction with adequate fidelity. LED performance parameters such as nominal intensity operating regime and current levels, relative wavelength insensitivity to ambient and junction temperature, and optical bandwidth must be optimized for the present application. When used as primaries for color reproduction, narrowband LEDs permit increased color display gamuts but can worsen metamerism, whereas broadband LEDs, by filling in spectrum, can diminish metamerism at the expense of more limited gamuts.

In the paper by Ramanath, (R. Ramanath, “Minimizing observer metamerism in display systems,” Color Research and Application, Vol. 34, pp. 391-398, 2009), observer metameric failure for different types of displays having three primaries is examined. In particular, Ramanath explores the comparative occurrence of observer metameric failure among different electronic display devices, including cathode ray tube (CRT) displays, liquid crystal display (LCD), digital light processor (DLP) and LED based displays, a cold cathode fluorescent lamp (CCFL) based display, and a laser display. Ramanath concludes that observer metameric failure can occur more frequently, and provide greater perceived color differences, as the display spectrum narrows (smaller FWHM) or the number of modes in the display spectrum increases. As a result, the laser display and CCFL display, which lack spectral color diversity due to narrow or multi-modal spectra, have a high propensity to cause observer metameric failure. By comparison, the CRT and lamp based DLP displays, which have broad primaries (Δλ of approximately 60-70 nm FWHM), exhibit low potential for observer metameric failure. In the case of laser displays, where the spectral bandwidths can easily be 2 nm or less in width, a small expansion of the lasing bandwidths, at the cost of a small color gamut decrease, would provide a reasonable trade-off if observer metameric failure is significantly decreased. However, Ramanath found that spectral distributions with moderate FWHM bandwidths (Δλ of about 28 nm), such as LED illuminated displays, can still produce significant perceptible observer metameric failure, suggesting that reductions in observer metameric failure may not come quickly with increases in spectral bandwidth.

It is critical to reduce observer metamerism in any method that seeks high fidelity color reproduction. As discussed previously, the present method invokes one of two alternative approaches to mitigation of observer metamerism. In one approach, the CMFs of the consumer are measured so that a product spectrum rendered against these consumer CMFs in an RGB display creates color reproduction fidelity. In the alternative approach, the product spectrum is mathematically optimized for a multi-primary display using LED wavelengths determined to reduce observer metamerism.

Further, there are two options for the former approach. In one, the vendor-published product spectrum is filtered by the measured consumer CMFs to provide drive signals to the red, green, and blue channels of a custom LED display, using three (or multiples thereof) LEDs. In the other, extant displays such as those of a smartphone, tablet, or monitor are calibrated against the measured consumer CMFs. A low cost spectrometer (of the DIY variety put into large scale production or the low cost kit for a smartphone spectrometer) can be employed for this purpose.

### RGB Custom Display

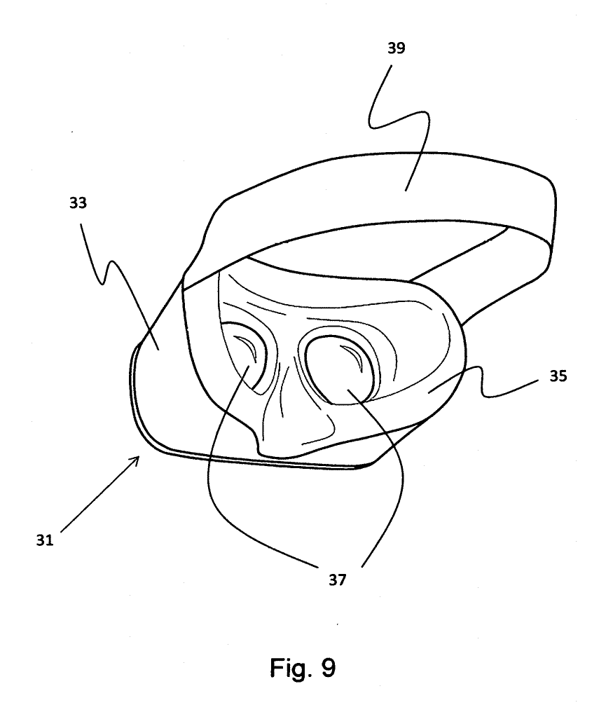

A custom three color LED-based display will render colors in accordance with the measured consumer's CMFs. Hence the wavelengths and optical bandwidths of the RGB primaries are not critical with respect to observer metamerism, but can be optimized for improved gamut. The display would be incorporated into a handheld unit after the fashion of FIG. 9.

### Preferred Embodiment of the Color Reproduction Display

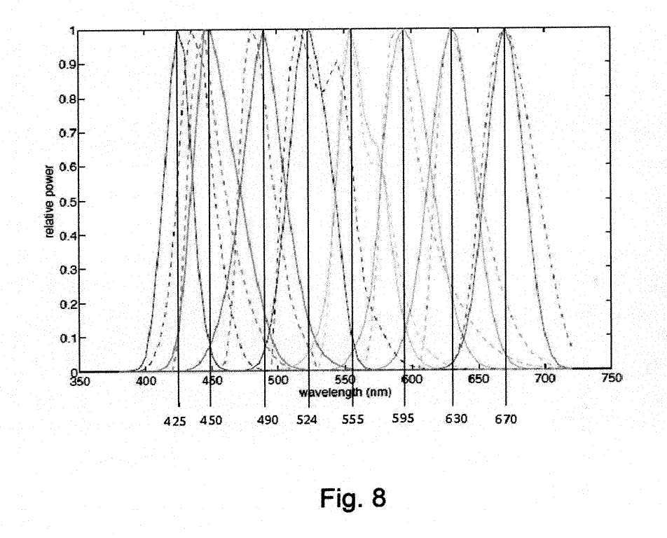

The aforementioned latter approach to reducing observer metamerism is based on some multi-primary display research (David Long, Mark D. Fairchild, “Reducing observer metamerism in wide-gamut multi-primary displays”, SPIE Proceedings Volume 9394, Human Vision and Electronic Imaging XX; 93940T (2015). It had been postulated that multi-primary design paradigms may hold value for simultaneously enhancing color gamut and reducing observer metamerism, considering expansion of the area spanned on the chromaticity diagram and increased spectrum sampling. This research determined that by carefully selecting primary spectra in systems employing more than three emission channels, intentional metameric performance can be controlled. Different wavelength sources were used to minimize observer metamerism against the CIE standard observer CMFs over an ensemble of reference spectra. The resulting 8 Gaussian model primaries are provided in FIG. 8. The identified wavelengths are 425, 450, 490, 524, 555, 595, 630, and 670 nm. Hence, the multi-primary display of the presently disclosed method and system employ LEDs with wavelengths such as these derived from minimum observer metamerism optimizations.

A preferred embodiment of the display device for the presently disclosed method and system is in the form of a headset 31 (similar to a virtual reality headset) which blocks ambient and background light as depicted in FIG. 9. The housing 33 is compact but sufficient to house optics and electronics. The molded interior 35 is designed to fit the facial contour and thereby prevent ambient light entry into the visual field when the head strap 39 is affixed to the head in snug fashion. Both left and right apertures 37 admit reproduced color light or can be used to display sequences of colors for the purpose of CMF measurement. The LEDs, color mixing optics, associated electronics and batteries are incorporated within.

Whether using a custom RGB three color LED display or an 8-primary LED display for variants of the presently disclosed method and system, attention must be paid to wavelength stability of the LEDs. As stated before, shifts in wavelengths approaching one to two nanometers are problematic given this is the threshold of change detectable by humans. Consideration must be given to how the wavelengths of LEDs selected for use in the custom RGB or multi-primary display can be made stationary over variation in drive level and ambient temperature.

Color mixing ratios require variable intensity of the individual LEDs. The intensity of the LEDs is altered either by continuous current (analog) dimming or by pulse width modulation (PWM) of constant current sources (ex. the integrated current source LT3083). Attempts to decouple LED drive level (current) from wavelength shifts have emphasized the latter approach. However, PWM does affect LED wavelength (Steven Keeping, “LED Color Shift Under PWM Dimming”, https://www.digikey.com/en/articles/techzone/2014/feb/led-color-shift-under-pwm-dimming). It turns out that the change in peak wavelength (and hence chromaticity) is due to the fact that lower duty cycles heat the LED p-n junction less than higher cycles. The physics is complex, but in essence, junction temperature alters the chromaticity because the LED's band gap (which determines the wavelength of emitted photons) narrows as the temperature rises. It is important to point out that LED wavelength shift due to aging is not a factor for the currently disclosed method and system because it takes thousands of hours before human observation would detect a change.

Given this state of affairs, remedies sought for tendencies to incur wavelength shift appear in the form of two approaches. In the first, the LED current nominally is set to correspond to the nominal target wavelength and nominal intensity and PWM is used to precisely establish LED intensity to satisfy color mixing ratios. In this case, wavelengths of the LEDs are sensed to provide feedback control of current drive, thereby maintaining constant wavelength.

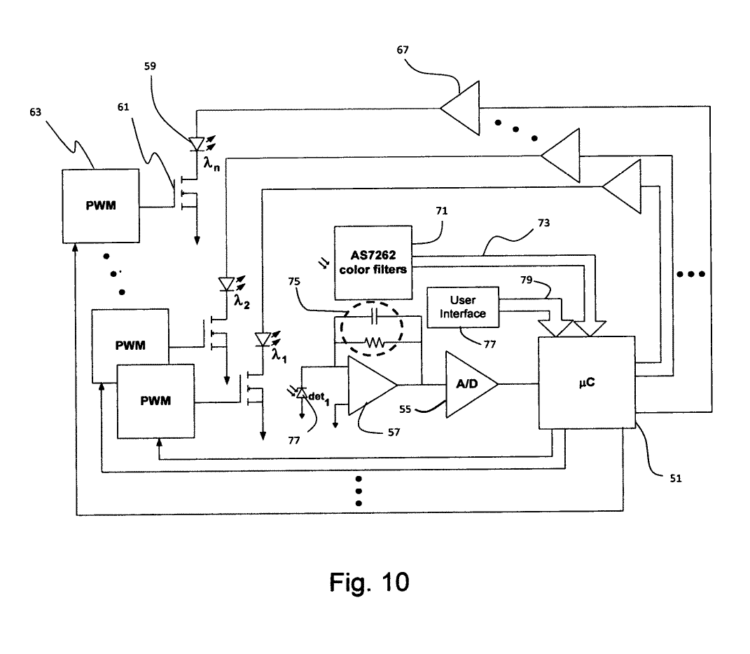

FIG. 10 details a candidate wavelength and intensity control circuit. Intensity and wavelength detection control LED current, whereas intensity detection controls PWM duty cycle for the purpose of color mixing. The PWM duty cycle is set corresponding to the appropriate color mixing value and then the current is adjusted to tune the wavelength. There may be some iteration in adjustment of PWM and current to maintain LED target intensity and target center wavelength. A processor or microcontroller 51 receives inputs from the user interface 77 that controls the mode of operation, i.e. as a color reproduction display or a CMF instrument. In the color reproduction mode, the user interface supplies the target color amplitude weights for color mixing. The processor 51 determines the appropriate duty cycle for the various pulse width modulators 63 to establish relative LED 59 intensities. The intensities of the LEDs 59 are measured by detector 77 in concert with the transimpedance amplifier 57 using feedback network 75. The analog output of this amplifier is converted by A to D converter 55 for input to processor 51. The modulators 63 control the current switches 61. The closed-loop current drive level for each LED 59 is established by processor 51 which communicates the corresponding voltage levels to programmable voltage sources 67 based upon the responses of the color filter chip (AS7262) 71. The integration time for the filter outputs of the AS7262 is 5.6 milliseconds, so continuous color control cannot be performed because the update rate would be below 400 Hz human perception flicker frequency. This implies intermittent closed-loop calibration of color, but this should not be problematic given the slow rate of color drift. In the CMF measurement mode, the processor 51 controls the display of bipartite color matching sequences and records user responses through the user interface in order to determine the user CMFs.

Different LED technologies, device geometries, and operating regimes exhibit different wavelength shift behavior with drive current and ambient temperature. For example, some surface mount LEDs undergoing large current changes only change dominant wavelength by 2 nm, whereas ambient temperature can shift wavelength +0.03 to 0.13 nm/degrees C. depending on die type. For the commercial temperature range of 0 to 70 degrees C., this would result in a center wavelength shift of between 2.1 and 9.1 nanometers. Also, the center wavelength and full-width-half-max (FWHM) of the spectrum vary with forward current. So closed loop wavelength control by current variation for this category of LEDs would be counterproductive. However, an LED with a small wavelength sensitivity to junction temperature, dλ/dT, tends to have a small wavelength sensitivity to forward current, dλ/dI_{F}.

The work of Raypah et al. evaluated several manufacturers of low power surface mount device (SMD) LEDs to determine that junction temperature approximately tracks ambient temperature at full forward current (Muna E. Raypah, Mutharasu Devarajan, and Fauziah Sulaiman, “Modeling Spectra of Low-Power SMD LEDs as a Function of Ambient Temperature”, IEEE Transactions on Electron Devices, February 2017, pp (99): 1-7.). For categories of low power SMD devices, this implies that a commercial temperature range swing results in the same junction temperature swing which makes low dλ/dT devices an acceptable paradigm. Hence, the best approach is to search out LEDs with small wavelength sensitivities to junction temperature and current and use bin selection to get under 1 nm error in initial peak wavelength. Then the system can be operated open loop with respect to LED wavelength control. PWM would be used in establishing color mixing ratios.

Examples of wavelength stable LEDs are given in the table below.

| | Temperature |
|---|---|
| | Sensitivity |
| LED Part | (nm/deg C.) |
| InGaN Mars Green LED Chip part | 0.030 |
| no. ES-CEGHM10A | |
| Seoul Semiconductor 801 Red Series | 0.026 |
| part no. SRT801-S/STR0A12AR | |
| LUXEON Rebel and LUXEON Rebel | 0.01 to 0.05 |
| ES Colors | |
| InGaN Cree ® TR5050 ™ | 0.048 |

Another consideration is to use multiple LEDs of the same wavelength for each of the primaries. This reduces drive current to any given LED by this same multiple, thereby reducing junction temperature which can be useful for wavelength stability.

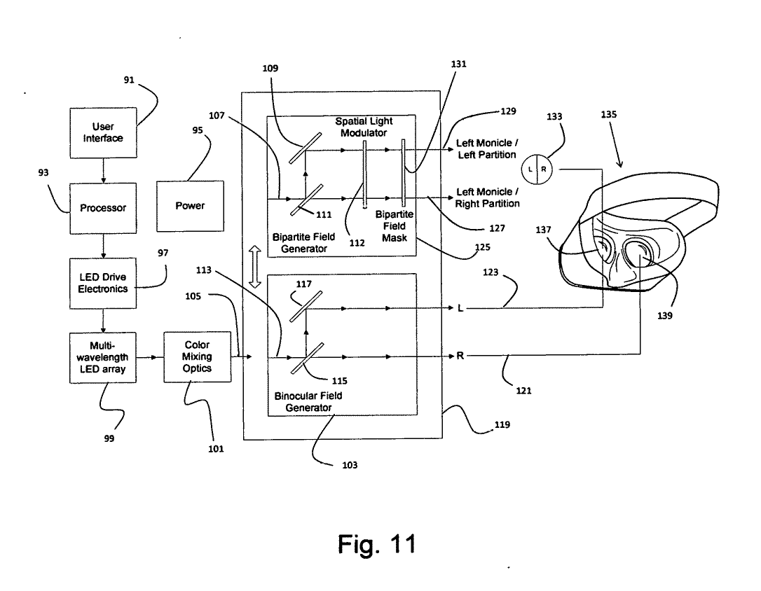

The comprehensive functionality of a custom display device is shown in FIG. 11. Included in the user interface is provision for data communication such as Bluetooth or USB input. Even keypad entry of coded data can be an option. If color data is provided by the vendor as a QR code (encoding over 7,000 digits of data), it can be read by a smartphone with appropriate app for export to the custom display device through Bluetooth, as an example. As previously described, the processor 93 governs how each device mode (color reproduction or CMF measurement) operates. In the color reproduction mode, the processor 93 provides LED control electronics 97 with the target LED drive levels and amplitude mixing ratios for energizing the LEDs of the multi-wavelength LED array 99 in accordance with the selected mode of operation. The outputs of the multi-wavelength LEDs are spatially homogenized in the color mixing optics 101. This type of display device can be used to achieve an RGB or a multi-primary implementation. A mechanical selection of function is depicted with the use of a sliding platform 119. Either the input optical axis 113 of the binocular field generator 103 (for color reproduction display) or the input optical axis 107 of the bipartite field generator 125 (for CMF measurement) can be selected to receive the output 105 of the color mixing optics 101. Such mechanical selection is sensed by processor 93 through switch sensor means not shown.

The binocular field generator 103 which creates two equal intensity optical fields is depicted as a simple combination of beamsplitter 115 and folding mirror 117. The left beam 123 and right beam 121 are directed to the headset display apertures 137 and 139, respectively. The bipartite field generator 125 depicts a beamsplitter 111 and folding mirror 109 that create right and left equal intensity bipartite beam paths. The spatial light modulator 112 provides different multiplexing of right and left bipartite beam paths that is synchronized with LED drive signals to create the disparate right and left visual fields as observed by the user. Element 131 represents a mask for limiting light leakage between right and left bipartite fields.

There is the additional prospect of including in this custom display device, low cost spectrometer functionality that can be used to capture the consumers lighting environment spectrum. As previously discussed, such spectral information can be combined with the product spectrum to produce a total spectrum which, upon display, would represent how the product would be perceived in the consumer's environment.

This display concept can be extended to the measurement and reproduction of multi-color patterns by sequential measurement of each color and concurrent display of the reproduced colors within the same visual field. It would be possible to create a number of smaller instantaneous fields of view within the right and left display apertures and the different colors could be displayed in parallel concurrently or by multiplexing. A vector of spectral measurements corresponding to the set of colors would be communicated to the consumer

### Other Display Primaries Technologies

In addition to the technologies advocated in a preferred embodiment of the custom display, use of other technologies is within the scope of the presently disclosed method and system, among them, laser diodes, narrowband optical filters, and narrowband phosphors.

Low cost, low power laser diodes potentially can be used as primary sources subject to techniques that assure eye safety as employed in laser-based projectors. Reduced intensities, spoiled spatial and/or temporal coherence, and divergence angle alteration can be used to achieve this objective.

Narrowband color filters can be used with LEDs to establish stable center wavelengths for primaries. If the given LED wavelength varies, the associated filter output center wavelength does not, but output intensity will vary. Then this intensity variation can be compensated by PWM of the LED.

An emerging technology applicable to the presently disclosed method and system comprises narrowband emission phosphors that can have emission spectra bandwidths of 5 to 10 nm. These phosphors can be pumped with broadband excitation. The saturation offered by these phosphors can significantly increase the color gamut of the displays for the present color reproduction application. While assuring center wavelength stability.

### Summary of the Methods of the Present Disclosure

The prior description of the devices that support execution of the methods of the present disclosure help to clarify those methods which are summarized below:
Use a spectrometer to measure the article color under standard illumination and process the measured spectrum to calculate the drive signals for a multi-primary display using spectral match optimization under standard CMF constraint. Publish this drive signal information for remote reproduction on a multi-primary display.
Use a spectrometer to measure the article total spectrum and the illumination spectrum and process the spectral data to produce an article reflectance spectrum. Publish this reflectance spectrum information. Measure the ambient illumination spectrum in the consumer's environment. Combine this spectrum with the article reflectance spectrum and process the resulting spectrum to calculate the drive signals for a multi-primary display using spectral match optimization under standard CMF constraint.
Use a spectrometer to measure the article color under standard illumination. Publish the spectrum information. Measure the consumer's CMFs. Filter the published spectrum information with the consumer's CMFs. Display resulting tristimulus values on an RGB display.
Use a spectrometer to measure the article total spectrum and the illumination spectrum and process the spectral data to produce an article reflectance spectrum. Publish the spectrum information. Measure the ambient illumination spectrum in the consumer's environment. Combine this spectrum with the article reflectance spectrum. Measure the consumer's CMFs. Filter the combined spectrum information with the consumer's CMFs. Display resulting tristimulus values on an RGB display.
Use a spectrometer to measure the article color under standard illumination. Publish the spectrum information. Measure the consumer's CMFs. Filter the published spectrum information with the measured consumer's CMFs to produce tristiumulus values. Calibrate the consumer's display with the consumer's measured CMFs. Display the color produced by the tristimulus values on the consumer's CMF-calibrated display.
Use a spectrometer to measure the article color under standard illumination. Publish the spectrum information. Measure the consumer's CMFs. Filter the published spectrum information with the measured consumer's CMFs to produce tristiumulus values. Display the color produced by the tristimulus values on a custom RGB display.
Use a spectrometer to measure the article total spectrum and the illumination spectrum and process the spectral data to produce an article reflectance spectrum. Publish the reflectance spectrum information. Measure the ambient illumination spectrum in the consumer's environment. Combine this spectrum with the article reflectance spectrum. Measure the consumer's CMFs. Filter the combined spectrum information with the measured consumer's CMFs to produce tristiumulus values. Display the color produced by the tristimulus values on the consumer's CMF-calibrated display.
Use a spectrometer to measure the article total spectrum and the illumination spectrum and process the spectral data to produce an article reflectance spectrum. Publish the reflectance spectrum information. Measure the ambient illumination spectrum in the consumer's environment. Combine this spectrum with the article reflectance spectrum. Measure the consumer's CMFs. Filter the combined spectrum information with the measured consumer's CMFs to produce tristiumulus values. Display the color produced by the tristimulus values on a custom RGB display.
Use a smartphone camera to display a scene, object, or color checker pattern and adjust the hues of the smartphone display to match the hues of the actual scene, object, or color checker pattern. Use the resulting display calibration data and the camera spectral responsivity to determine the user's CMFs. Import the vendor-provided product spectrum data and filter it with the user's CMFs and display the reproduced product color associated with the CMF-filtered product spectrum.

Those in the art will understand that a number of variations may be made in the disclosed embodiments, all without departing from the scope of the invention, which is defined solely by the appended claims.

1. A method of remote reproduction of article or product color that permits display of the article or product true color in avoidance of metamerism, the method comprising the steps of:
a. obtaining spectral information about the article or product,
b. using CMFs to mitigate observer metamerism,
c. publishing the spectral information in a form for consumer use, and
d. displaying in high fidelity the reproduced product color corresponding to the spectral information

2. A method of remote reproduction of product color as recited in claim 1 wherein the spectral information is obtained by spectroscopic means, and publishing is electronic, online, in email, or in print.

3. A method of remote reproduction of product color as recited in claim 1 wherein the spectrum information comprises product composite spectrum and illumination type, step b comprises:
i. measuring the consumer's CMFs and
ii. calibrating a display to the consumer's CMFs,
and step d includes:
i. filtering the composite spectrum with the consumer's CMFs and
ii. displaying of the color associated with the filtered composite spectrum on the calibrated display.

4. A method of remote reproduction of product color as recited in claim 3 wherein the step of measuring the consumer's CMFs comprises:
i. adjusting a smartphone display in camera viewfinder mode to match the consumer's color perception of a plurality of printed calibration colors under controlled illumination, and
ii. extracting the resulting display profile to effectively measure the consumer's CMFs, and
wherein displaying of the color of the filtered composite spectrum is done on the smartphone display.

5. A method of remote reproduction of product color as recited in claim 3 wherein the step of measuring the consumer's CMFs comprises:
i. adjusting a smartphone display in camera viewfinder mode to match the consumer's color perception of a plurality of real scenes, and
ii. extracting the resulting display profile to effectively measure the consumer's CMFs, and
wherein displaying of the color of the filtered composite spectrum is done on the smartphone display.

6. A method of remote reproduction of product color as recited in claim 1 wherein the spectrum information comprises product composite spectrum and illumination type, step b comprises:
i. measuring the consumer's CMFs and
ii. filtering the composite spectrum with the consumer's CMFs to produce a filtered spectrum,
and step d comprises displaying the color associated with the filtered spectrum on a custom RGB display.

7. A method of remote reproduction of product color as recited in claim 1 wherein the spectrum information comprises the reflectance spectrum, step b comprises:
i. measuring the consumer's CMFs and
ii. calibrating a display to the consumer's CMFs,
the following additional steps included after step c and before step d comprise:
i. measuring the consumer's illumination spectrum, and
ii. calculating the composite spectrum,
and step d further comprises displaying the color associated with the composite spectrum on the display calibrated to the consumer's CMFs.

8. A method of remote reproduction of product color as recited in claim 1 wherein the spectrum information comprises the reflectance spectrum, step b comprises:
i. measuring the consumer's CMFs and
ii. filtering the composite spectrum with the consumer's CMFs to create a filtered spectrum,
the following additional steps included after step c and before step d comprise:
i. measuring the consumer's illumination spectrum, and
ii. calculating the composite spectrum, and
wherein step d further comprises displaying the color associated with the composite spectrum on a custom RGB display.

9. A method of remote reproduction of product color as recited in claim 1 wherein the spectrum information comprises composite spectrum and illumination type, step b comprises:
i. providing a multispectral display with primary wavelengths selected to minimize observer metamerism and
ii. performing a spectral match to the primaries of the multi-primary display under a standard CMF colorimetric matching constraint to reproduce the color of the product, and
wherein step d further comprises displaying the reproduced product color with the multispectral display.

10. A method of remote reproduction of product color as recited in claim 1 wherein the spectrum information comprises composite spectrum and illumination type, step b comprises:
i. providing a multispectral display with primary wavelengths selected to minimize observer metamerism,
ii. measuring the consumer's CMFs, and
iii. performing a spectral match to the primaries of the multi-primary display under a consumer CMF colorimetric matching constraint to reproduce the color of the product, and
wherein step d further comprises displaying the reproduced product color with the multispectral display.

11. A method of remote reproduction of product color as recited in claim 1 wherein the spectrum information comprises the reflectance spectrum, step b comprises:
i. providing a multispectral display with primary wavelengths selected to minimize observer metamerism and
ii. performing a spectral match of the multi-primary display under a standard CMF colorimetric matching constraint to a composite spectrum upon the calculation of the composite spectrum from the reflectance spectrum and a measured consumer's illumination spectrum, and
wherein the following additional steps included after step c and before step d comprise:
i. measuring the consumer's illumination spectrum, and
ii. calculating the composite spectrum, and
wherein step d further comprises displaying the color associated with the composite spectrum on the multispectral display.

12. A method of remote reproduction of product color as recited in claim 1 wherein the spectrum information comprises the reflectance spectrum, step b comprises:
i. providing a multispectral display with primary wavelengths selected to minimize observer metamerism,
ii. measuring the consumer's CMFs, and
iii. performing a spectral match of the multi-primary display under a consumer CMF colorimetric matching constraint to a composite spectrum upon the calculation of the composite spectrum from the reflectance spectrum and a measured consumer's illumination spectrum, and
the following additional steps are included after step c and before step d comprise:
i. measuring the consumer's illumination spectrum, and
ii. calculating the composite spectrum,
and wherein step d further comprises displaying the color associated with the composite spectrum on the multispectral display.

13. A method of remote reproduction of article or product color that permits display of the article or product true color in avoidance of metamerism, the method comprising the steps of:
a. Measuring a consumer's CMFs by using a smartphone with camera function, further comprising the steps:
i. Using the smartphone display in camera viewfinder mode observed a colored scene, object, or color checker pattern to match the hues of the actual scene, object, or color checker pattern,
ii. Determine the user CMFs, given the display calibration and the spectral responsivity of the smartphone camera
b. Import vendor supplied spectrum information that includes product spectrum to the smartphone
c. Filter the product spectrum with the user CMFs
d. Display on the smartphone the color of the product associated with the CMF-filtered product spectrum

14. A system for sensing and remote reproduction of color comprising:
a. a spectrometer for measuring an article's spectrum in the vendor's environment,
b. software for optimizing the reproduction of the spectrum by a set of multi-wavelength LEDs,
c. processing means hosting the software, and
d. a display device comprising:
i. a plurality of LEDs of multiple wavelengths,
ii. a color mixer,
iii. processing means for controlling color mixing,
iv. LED drive electronics, and
v. a user interface.

15. A system for sensing and remote reproduction of color as recited in claim 14 further comprising:
a. a spectrometer for measuring an the consumer's illumination spectrum and
b. processing means for calculating a composite spectrum from a reflectance spectrum and an illumination spectrum.

16. A system for sensing and remote reproduction of color as recited in claim 15 wherein the spectrometer for measuring the consumer's illumination spectrum and processing means for calculating a composite spectrum are made part of the display device.
